(19) United States
(12) Patent Application Publication
(10) Pub. No.: US 2007/0244919 A1
(43) Pub. Date: Oct. 18, 2007

(54) RESOURCE ASSOCIATION

(75) Inventors: Martin James Wells, Kingsford (AU); Rhandy Lado, Haymarket (AU)

Correspondence Address: KNOBBE MARTENS OLSON & BEAR LLP, 2040 MAIN STREET, FOURTEENTH FLOOR, IRVINE, CA, 92614, US

(73) Assignee: Tangler Pty Ltd, Ultimo (AU)

(21) Appl. No.: 11/697,245

(22) Filed: Apr. 5, 2007

Related U.S. Application Data
(60) Provisional application No. 60/789,977, filed on Apr. 6, 2006.

(51) Int. Cl. G06F 7/00

(52) U.S. Cl. 707/102

(57) ABSTRACT

A method of associating a resource attribute and a discussion topic is disclosed. In one embodiment, the method includes, in an end station, in response to display of at least one of a resource and a topic, and following user input indicative of a create association request, generating an association request indicative of a topic and at least one resource attribute. The association request is transferred to a base station, which is responsive to the association request to generate association data indicative of the association between the resource attribute and the topic.

### RELATED APPLICATIONS

This application claims priority under 35 U.S.C. § 119(e) from provisional application No. 60/789,977 filed on Apr. 6, 2006, which is hereby incorporated by reference.

### BACKGROUND OF THE INVENTION

1. Field of the Invention

The present invention relates to a method and apparatus for associating a resource or resource attribute and a discussion topic, as well as a method and apparatus for viewing content associated with a resource or discussion topic.

2. Description of the Related Technology

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Currently a wide range of chat or discussion groups exist. Access to these groups is typically achieved utilizing a software application that presents an interface to an end user allowing the user to view current discussion topics, and selectively participate in discussions as desired. One issue with applications of this form is that it is often difficult to locate discussion groups that are relevant to the user's interests.

Thus for example when a user is viewing a web-page, the user may have questions regarding the content of a page which could be answered via an appropriate discussion group. To locate such a group however it is generally necessary to access a discussion group index via a separate application and then manually search the discussion groups relating to the relevant topic. This is a time consuming process that often does not lead the user to relevant discussion topics.

An attempt has been made to address such problems by providing a specific chat group associated with a respective web-page. This relies on a one-to-one static mapping between the web-page and a chat group, so that each time the web-page is displayed, the user can view the associated chat group. Whilst this allows users to discuss a web-page, this still leads to a number of drawbacks.

For example, the association is static and typically created by either the web-page host, or a host of chat room services. This means users are restricted to using the specified chat group for discussing the web-page. Secondly, there may many different chat groups relevant to the web-page which cannot be identified using this technique. Similarly there may be many resources that are potentially relevant to a given chat room that cannot be located using this mechanism.

This also limits the ability of end user to create or at least suggest associations, as these are typically defined by the service hosts. This allows service hosts to control viewable content, which may not be desirable for end users. Finally, there are many different types of resource for which this mechanism is not suitable.

### SUMMARY OF CERTAIN INVENTIVE ASPECTS

One aspect of the present invention provides a method of associating a resource attribute and a discussion topic, wherein the method includes, in an end station:
a) in response to display of at least one of a resource and a topic, and following user input indicative of a create association request generating an association request indicative of:
   i) a topic; and,
   ii) at least one resource attribute;
b) transferring the association request to a base station, the base station being responsive to the association request to generate association data indicative of the association between the resource attribute and the topic.

Typically the method includes, in the end station:
a) causing a create association indication to be displayed together with the displayed at least one of the resource and the topic; and,
b) generating the association request in response to user selection of the create association indication.

Typically the method includes, in the end station, in response to the display of a resource:
a) causing a list of available topics to be displayed; and,
b) in response to user input, determining a topic by at least one of:
   i) selecting one of the list of available topics; and,
   ii) creating a new topic.

Typically the method includes, in the end station:
a) causing a list of resources attributes to be displayed; and,
b) in response to user input, determining the at least one resource attribute by at least one of:
   i) selecting one of the list of resources attributes; and,
   ii) creating a new resource attribute.

Typically the resource attribute is at least one of:
a) partially based on resource metadata;
b) a URL;
c) a filename;
d) a resource author;
e) a resource title;
f) EXIF information; and,
g) a file property.

Typically the topic is at least one of:
a) a discussion thread;
b) a discussion group; and,
c) a chat room.

Typically the resource is at least one of:
a) a web-page;
b) an RSS feed;
c) a document;
d) a video sequence;
e) an image;
f) multimedia content; and,
g) a data file.

Typically the method includes, in an application executed by the end station:
a) determining the display of a resource by a second application executed by the end station;
b) causing a create association indication to be displayed;
c) determining user selection of the create association indication;
d) causing an interface to be displayed showing a list of available topics;
e) determining user selection of at least one of:
   i) one of the list of available topics; and,
   ii) a new topic;
f) causing an interface to be displayed showing a list of resource attributes associated with the displayed resource;
g) determining user selection of at least one of:
   i) one of the list of available resource attributes; and,
   ii) a new resource attribute;
h) generating the association request; and
i) transferring the association request to the base station.

Typically the method includes, in an application executed by the end station:
a) determining the display of a topic by the application;
b) displaying a create association indication;
c) determining user selection of the create association indication;
d) displaying an interface showing a list of at least one of:
   i) resource attributes; and,
   ii) resources;
e) determining user selection of at least one of at least one resource attribute using the interface;
f) generating the association request; and
g) transferring the association request to the base station.

Typically the method includes, in the end station:
a) displaying a create association web-page hosted by a base station, the user being responsive to the create association web-page to provide details of at least one of the topic and the at least one resource attribute;
b) generating at least one browser message representing the association request; and,
c) transferring the at least one browser message to the base station.

Typically the method includes, in the end station:
a) displaying a first web-page hosted by a processing system, the first web-page including a create association indication;
b) determining user selection of the create association indication;
c) transferring a browser message to the processing system, the processing system being responsive to the browser message to cause the create association web-page to be displayed by the end station.

Typically the base station includes the processing system.

Another aspect of the present invention provides a method of associating a resource and a discussion topic, wherein the method includes, in a base station:
a) receiving, from an end station, an association request indicative of:
   i) at least one topic;
   ii) at least one resource attribute;
b) using the association request to generate association data indicative of an association between the resource attribute and the topic.

Typically the method includes, in the base station:
a) causing the end station to display a create association web-page, the user being responsive to the create association web-page to provide details of at least one of the topic and the at least one resource attribute; and,
b) receiving at least one browser message representing the association request.

Typically the method includes, in the base station, hosting the create association web-page.

Typically the method includes, in the base station:
a) causing the end station to display a first web-page, the first web-page including a create association indication, the end station being responsive to user selection of the create association indication to generate a browser message; and,
b) receiving the browser message; and,
c) causing the create association web-page to be displayed by the end station.

Another aspect of the present invention provides a method of viewing content associated with at least one of a resource and a discussion topic, the method including, in an end station:
a) generating, in response to display of at least one of a resource and a topic, a content request;
b) transferring the content request to a base station, the base station being responsive to the content request to:
   i) generate an association indication indicative any associated content, and,
   ii) transfer the association indication to the end station; and,
c) using the association indication to display a content indication indicative of any content to the user.

Typically the method includes, in the end station:
a) causing the content indication to be displayed together with the displayed at least one of the resource and the topic;
b) determining selection of the content indication in accordance with user input; and,
c) causing the display of any associated content.

Typically the content indication is indicative of a number of content items.

Typically the method includes, in the end station:
a) determining at least one resource attribute associated with a displayed resource; and,
b) generating the content request indication using the at least one resource attribute.

Typically the method includes, in the end station:
a) determining at least one detail associated with a displayed topic; and,
b) generating the content request indication using the at least one detail.

Typically the content is at least one of a topic and a resource.

Typically the topic is at least one of:
a) a discussion thread;
b) a discussion group; and,
c) a chat room.

Typically the resource is at least one of:
a) a web-page;
b) an RSS feed;
c) a document;
d) a video sequence;
e) an image;
f) multimedia content; and,
g) a data file.

Typically the method includes, in an application executed by the end station:
a) determining the display of a resource by a second application executed by the end station;
b) determining at least one resource attribute associated with the resource;
c) generating the content request in accordance with the determined at least one resource attribute;
d) transferring the content request to the base station;
e) receiving the association indication from the base station; and,
f) causing the content indication to be displayed.

Typically the method includes, in an application executed by the end station:
a) determining the display of a topic;
b) generating the content request in accordance with the displayed topic;
c) transferring the content request to the base station;
d) receiving the association indication from the base station; and,
e) causing the content indication to be displayed.

Still another aspect of the present invention provides a method of viewing content associated with at least one of a resource and a discussion topic, the method including, in a base station:
a) receiving, from an end station, a content request indicative of at least one of a resource attribute and a topic;
b) using the content request to determine associated content;
c) generate an association indication indicative any associated content; and,
d) transfer the association indication to the end station, the end station using the association indication to display a content indication indicative of any content to the user.

Typically the method includes, in the base station, using at least one resource attribute to search content to thereby locate associated content.

Typically the method includes, in the base station determining associated content using association data indicative of any associations between resource attributes and topics.

Typically the content is at least one of a topic and a resource.

Still another aspect of the present invention provides apparatus for associating a resource attribute and a discussion topic, wherein the apparatus includes, an end station for:
a) in response to display of at least one of a resource and a topic, and following user input indicative of a create association request, generating an association request indicative of:
   i) a topic; and,
   ii) at least one resource attribute;
b) transferring the association request to a base station, the base station being responsive to the association request to generate association data indicative of the association between the resource attribute and the topic.

Still another aspect of the present invention provides apparatus for associating a resource and a discussion topic, wherein the apparatus includes a base station for:
a) receiving, from an end station, an association request indicative of:
   i) at least one topic;
   ii) at least one resource attribute;
b) using the association request to generate association data indicative of an association between the resource attribute and the topic.

Yet another aspect of the present invention provides apparatus for viewing content associated with at least one of a resource and a discussion topic, the apparatus including an end station for:
a) generating, in response to display of at least one of a resource and a topic, a content request;
b) transferring the content request to a base station, the base station being responsive to the content request to:
   i) generate an association indication indicative any associated content, and,
   ii) transfer the association indication to the end station; and,
c) using the association indication to display a content indication indicative of any content to the user.

Yet another aspect of the present invention provides apparatus for viewing content associated with at least one of a resource and a discussion topic, the apparatus including a base station for:
a) receiving, from an end station, a content request indicative of at least one of a resource attribute and a topic;
b) using the content request to determine associated content;
c) generate an association indication indicative any associated content; and,
d) transfer the association indication to the end station, the end station using the association indication to display a content indication indicative of any content to the user.

At least one aspect of the invention may be used independently, or in conjunction.

### BRIEF DESCRIPTION OF THE DRAWINGS

Embodiments of the present invention will now be described with reference to the accompanying drawings.

FIG. 1 is a schematic diagram of an example of a computer network environment.

FIG. 2 is a schematic diagram of an example of the base station of FIG. 1.

FIG. 3 is a schematic diagram of an example of the end station of FIG. 1.

FIG. 4 is a flow chart of an example of the process of associating resource and a discussion topic.

FIG. 5 is a flow chart of an example of the process of viewing associated content.

FIG. 6 is a flow chart of a specific example of the process of associating resource and a discussion topic.

FIGS. 7A and 7B are a flow chart of a specific example of the process of viewing associated content.

FIGS. 8A and 8B are schematic diagrams of examples of graphical user interfaces used for creating an association.

FIGS. 9A and 9B are schematic diagrams of examples of graphical user interfaces used for selecting discussion groups.

FIG. 10 is a schematic diagram of an example of a graphical user interface for selecting a resource.

FIG. 11 is a schematic diagram of an example of a graphical user interface for participating in discussions.

FIG. 12 is a schematic diagram of an example of a graphical user interface for viewing associated content.

### DETAILED DESCRIPTION OF CERTAIN INVENTIVE EMBODIMENTS

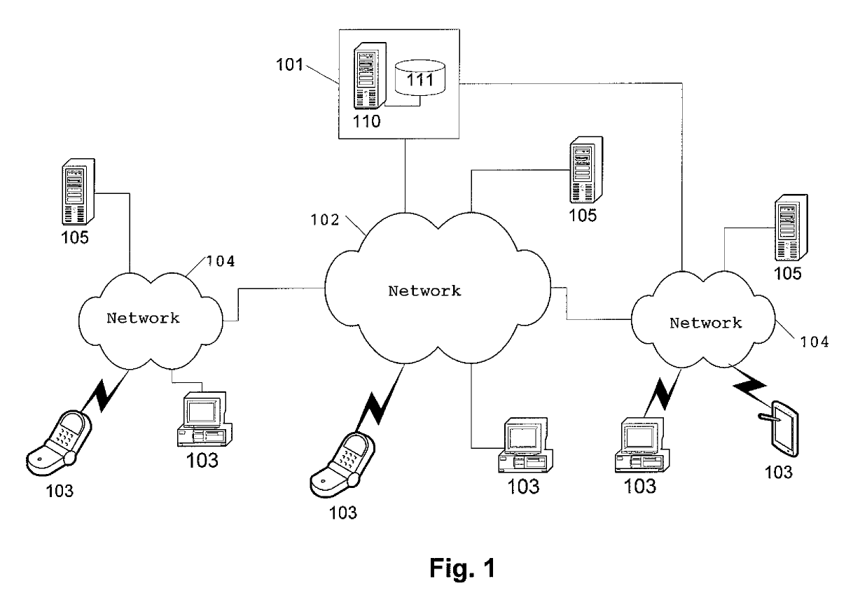

An example of a system for use in associating resource(s) and discussion topic(s) and/or discussion group(s), and viewing associated content will now be described with reference to FIGS. 1 to 3.

In this example, the system includes a base station 101 coupled to a number of end stations 103, 105, via communications networks 102, 104. The communications networks 102, 104 may be communications networks such as the Internet, one or more Local Area Networks (LANs) one or more Wide Area Networks (WANs), Wireless Networks such as the GPRS, 3G Networks, or the like. The base station 101 typically includes one or more processing systems 110, which may be coupled to a database 111, or the like, as shown.

In use, the end stations 103 are adapted to display resources to user, as well as allowing users to participate in discussion forums, such as discussion topics, discussion groups, chat rooms or the like. The end stations 103 can also be used to allow users to create associations between resources, topics, groups and the like, as will be described in more detail below. Associations can be maintained by the base station 101, which also operates to provide information regarding associations to allow associated content to be displayed to users, via the end stations 103. In this example, the end stations 105 may be used for hosting resources and/or discussion topics, groups or the like, as well as to allow associations to be created or viewed.

Accordingly, it will be appreciated that the terms end station 103 and end station 105 are merely used for the purpose of illustration to distinguish between devices used for viewing content, resources and allowing user participation in discussions, and devices for hosting content, whereas in practice the devices could be used interchangeably, or for either purpose.

In any event, it will be appreciated that each of the end stations 103, 105 and the base station 101 are typically adapted to communicate via the communications networks 102, 104, whilst the base station 101 is typically also adapted create and maintain details of associations, as will be described in more detail below. Accordingly, it will be appreciated that any suitable form of end station 103, 105 and base station 101 may be used.

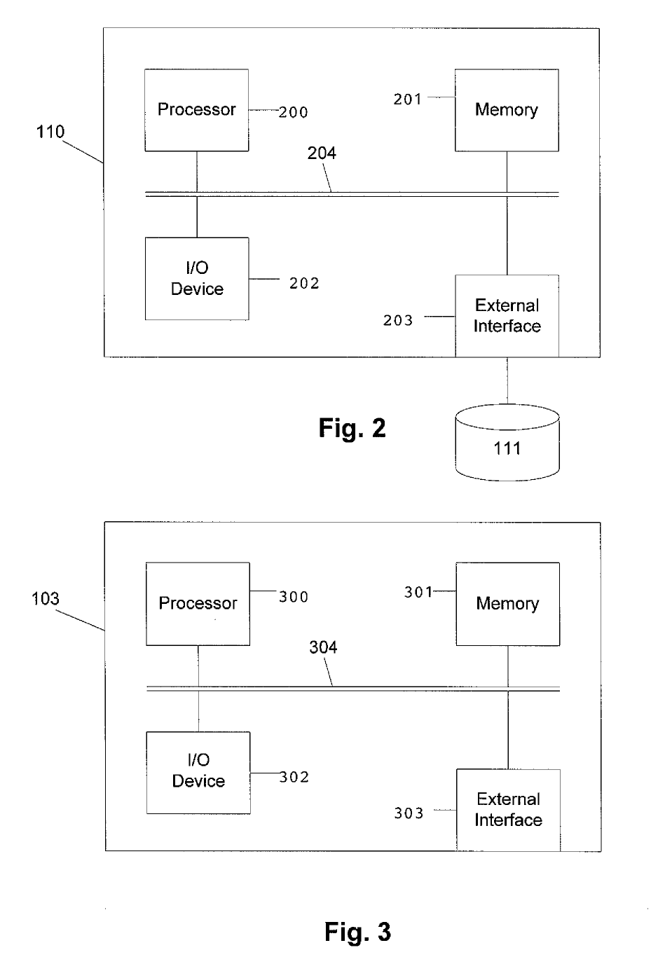

An example of a processing system 110 is shown in FIG. 2. As shown the processing system 110 includes a processor 200, a memory 201, an input/output device 202, such as a keyboard and display or the like, and an external interface 203, coupled together via a bus 204. In use the external interface 203 may be coupled to the database 111, as well as providing connections to the communications networks 102, 104.

Accordingly, the processing system 110 may be any form of processing system, such as a computer server, a network server, a web server, a desktop computer, a lap-top or the like. Alternative specialized hardware may be used.

Similarly, as shown in FIG. 3, the end stations 103, 105 may be formed from a processor 300, a memory 301, an input/output device 302 and an external interface 303, coupled together via a bus 304. Again the external interface 303 may be used to provide a connection to the communications networks 102, 104.

Accordingly the end station 103 may be any form of computer system such as a desktop computer, lap-top, specialized hardware or the like, which is typically executing applications software to enable data transfer and in some cases web-browsing, or the like. Similarly, the end stations 105 may be any form of computer system, and when hosting content or resources, are typically in the form of a network server, web server, or the like.

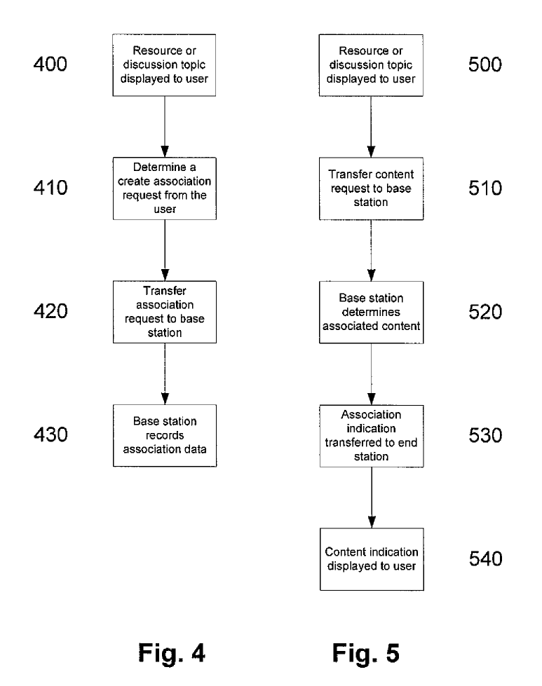

An example of a process for creating a binding that associates a discussion topic or resource with other topics or resources will now be described with reference to FIG. 4.

In this example, a resource, discussion topic or discussion group is displayed to a user at step 400. This may be achieved in any one of a number of manners depending on the preferred implementation. Thus, for example, this may involve using a third party application, such as viewing web pages via a web browser, or participating in a chat room using a chat application. Alternatively, custom client software may be used, as will be described in more detail below.

At step 410 a create association request is made by the user, which causes the end station 103 to generate an association request, which is transferred to the base station at step 420. The association request is used by the end station 103 to request the creation of an association, and may be of any suitable form depending on the preferred implementation. For example, if the application executed by the end station 103 is a browser application, this may be in the form of one or more browser messages, whereas for a custom client application, any suitable message format may be used.

The association may be created directly between a resource and a discussion topic. However alternatively the association can be made with an attribute of the resource, as this may prove more useful than binding the topic to the resource itself. For example, if the resource is a music file, it is typically more useful to associate information regarding the music file, such as the song title, an album title, or a band name, with the discussion topic, rather than the music file itself, as will become apparent from the explanation below.

At step 430 the base station records the association. This may be performed in any one of a number of ways but typically involves storing association data in a store such as the database 111, or the like, allowing the association to be subsequently identified, and used to allow associated resource or resource attributes and/or discussion topics to be identified.

Following, during or before, the recording of the association, the base station 101 may notify the end station 105 hosting the resource or discussion topic, thereby allowing entities providing the resource or discussion topic to be made aware of the association. For example, if a member of a discussion group creates an association between the discussion group and an external resource, such as a “blog” (web log), an indication of this can be sent to the blogger and/or the entity hosting the blog. This allows the blogger or other entity to modify the blog to acknowledge the association for example, by incorporating a link to the discussion group from the blog, providing comments on the discussion group, or the like.

Following the creation of associations, the associations can be used to provide links between associated resources and corresponding discussion groups (which are sometimes referred to as being “bound” to the associated resources). In one example, this can be achieved by embedding appropriate links within resources and/or discussion topics or groups. Thus, if a discussion forum is provided as a web-page, this can involve embedding a hyperlink within the group to an associated resource. In the event that discussion groups are hosted by the base station 101, then this can be easily achieved using the recorded association. As an alternative however, this can be achieved by any entity hosting resources or discussion groups based on notification of associations by the base station 101. A further alternative is for the end station 103, query the base station 101 regarding any associations upon display of resources and/or discussion groups or topics.

It will be appreciated that this process therefore allows users to bind resources and discussion topics or groups by creating associations. This allows a wide range of flexibility allowing one-to-one, many-to-one, one-to-many and many-to-many associations to be created. These associations can then be embodied as links allowing easy navigation between resources and/or discussion groups or topics.

Additionally, associations can be used in a discovery process to display associated content as will now be described with reference to FIG. 5.

In this example, at step 500 the end station 103 displays a resource or discussion topic to a user in a similar manner to that described with respect to step 400. At step 510 the end station 103 will transfer a content request to the base station 101, requesting details of any associated content. The content request may be in the form of one or more browser messages, or custom generated message, depending on the implementation, such as whether the end station 103 implements a browser application and/or custom client applications software.

At step 520 the base station determines associated content either by examining the association data or by other means, such as performing a search or discovery process. Thus, for example, this can involve determining attributes of a currently displayed resource, with these being used as search terms in a discovery process.

It will be appreciated from this, that the associated content can include resources and/or topics linked to the current resource or topic via a defined association. Additionally or alternatively, the associated content can include other content that is associated with the currently viewed resource or topic as a result of the search or discovery process.

The base station 101 then transfers details of the associated content to the end station 103 in the form of an association indication at step 530. The end station 102 uses this to display a content indication to the user at step 540, indicating to the user any available associated content.

This content indication can provide a range of different types of information regarding the content, depending for example on the preferred implementation and/or user preferences. Thus, for example, the content indication can indicate a number of related content instances, with selection of the content indication allowing the user to view additional information. Additionally, or alternatively, the content indication can indicate current usage of the topics and/or resources by other users, as will be explained in more detail below. However, it will be appreciated that any suitable indication may be used.

It will therefore be appreciated that the above described process therefore allows chat or discussion topics to be linked to resources, which may be performed via resource attributes, and vice versa. The consequence of this is that when a discussion topic, or a resource is used, this allows associated content such as other resources, resource attributes or other discussion topics to be displayed to the user.

The creation of an association is typically performed based on user input. However, once defined, associations can be accessed automatically, such that when a user views a resource or discussion topic, associated content is automatically indicated to the user through a suitable notification such as a system tray icon, menu option or the like. This allows users to easily locate and review associated content without having to initiate searching processes.

It will be appreciated that the resource may be any form of resource, such as an Internet page, a multi-media file, such as an MP3 music file, MP4 video file, or the like. Alternatively, the resource can be any other type, such as photos, RSS (Rich Site Summary) feeds, Word documents, or the like.

The resource attribute can then be based on properties, or other data associated with the file. This can include, but is not limited to resource metadata, a URL, a filename, details of a resource author or host, a resource title, EXIF (Exchangeable Image File) information, a file property, or the like. The resource attributes can also encompass additional factors, such as aspects of the viewing of the resource, such as the user's location, and the date on which the association is created. Similarly, such information can be used when viewing associated content, to thereby provide geographical relevance to the end user.

Similarly, whilst the above described example is with respect to a discussion topic this can additionally or alternatively be applied to any form of discussion environment or forum, including but not limited to discussion groups, discussion topics, chat rooms, IRC (Internet Relay Chat) channels, as well as any other two way communication process where a specific environment is defined for discussing a respective subject.

Accordingly, the above described process allows associations to be created between discussion forums, such as discussion groups, and resources such as web pages, blogs, multimedia, or the like. Once associations are defined, this allows links to be provided, allowing users to navigate from discussion topics to resources, and vice versa. The associations can be defined using custom client applications software, generic browser applications, or a combination of the two, for example through the use of software such as a toolbar, java application, or the like, which interacts with a generic browser. Similarly, associations may also be accessed via client applications software, and/or via a generic browser, for example through the use of links embedded in web-pages, discussion groups, or the like.

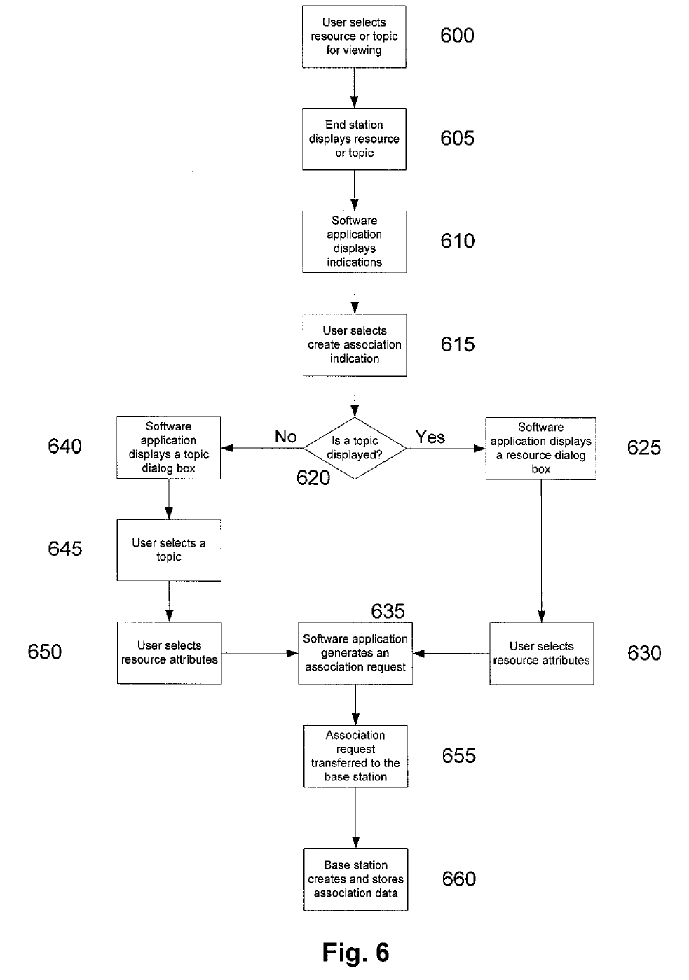

A specific example of the process of creating an association will now be described in more detail with respect to FIG. 6.

At step 600 the user uses the end station to select a resource or topic for viewing, with this being displayed to the user at step 605. This may be achieved in any one of a number of ways. For example, the end station 103 can execute a custom client software application that allows user to view resources and/or discussion topics, and then create associations.

An example of this is shown in FIG. 11, which shows a graphical user interface (GUI) presented by the client software application for performing chat based communications. In this example, the GUI 1100 includes a group list 1101, a group window 1102 and a contact list 1103. In use, the group list 1101 includes a list of available groups, such as discussion groups to which the user is currently subscribing, or the like. For a currently selected group, details are displayed in the group window 1102, including a list of available discussion topics 1104, current messages within a selected topic 1105, and a message input 106 to allow a user to add messages.

Alternatively, resources may be viewed via third party software applications, such as browser applications including Internet Explorer™, or the like, or specific applications including iTunes, or the like, depending on the resource used. In other words, resources can be viewed using default applications installed on the end stations 103 that allow interaction with the relevant resource. Similarly, default communications programs may be used for viewing or otherwise interacting within a chat environment.

In either case, at step 610, a software application executed by the end station 103 operates to display one or more indications to the user, including at least a create association indication. This can be in any one of a number of forms, such as a suitable icon, menu option or the like, or alternatively an embedded link within a web-page, or the like, depending on the preferred implementation.

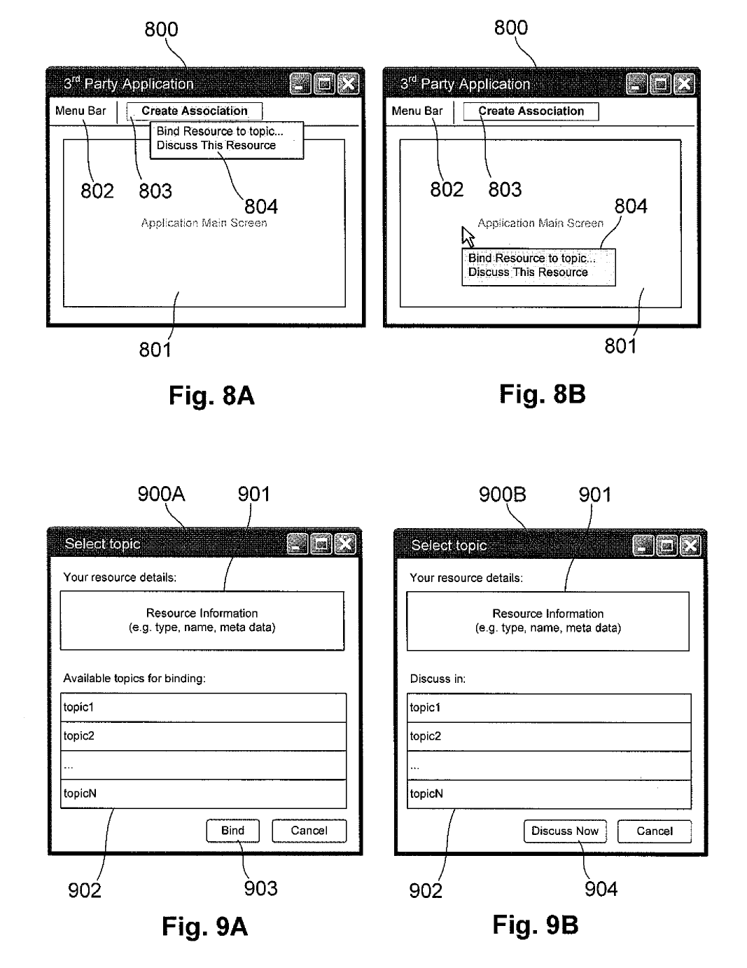

In one example, if third party software is used to view the resource or topic, this can use the GUI utilized by the third party software, as shown for example in FIG. 8. In this example, the GUI 800 includes a main window 801, which may be used for displaying the resource or topic, and a menu bar 802. The create association indication is shown at 803, as an option on the menu bar 802. This leads to a drop down menu 804 that allows users to select a bind or discuss option. As an alternative, the drop down menu may be accessible using other input commands, such as a right mouse click in the main window 801, as shown in FIG. 8B. From this, it will be appreciated that the client software application could be formed from an add-on to the third party application, such as a toolbar or plug-in.

In the event that client software is used to view the resource, a similar procedure will occur using the GUI shown in FIG. 11.

In either case, at step 615 the user selects the create association indication by clicking on the associated option using an input device such as the mouse or the like.

As a further alternative however the resource or discussion topic can contain embedded commands, which act as the create association indication, for triggering the binding process. This can be achieved for example by using a hyperlink, which upon selection directs the browser application to a web-page, hosted by the base station 101, which allows an association to be created. As a further alternative, the ability to drag and drop details of an association into a frame on a web-page may also be provided. Thus, for example, if a web-page displaying discussion groups is presented by the browser application, then dragging a link to a resource can be used to trigger the create association process, and therefore act as a create association request.

It will be appreciated from the above description that a wide range of different triggering mechanisms may be employed to initiate the create association process and the above examples are for the purpose of illustration only.

Once the binding process is triggered, it is then necessary to obtain information to allowing the association to be created.

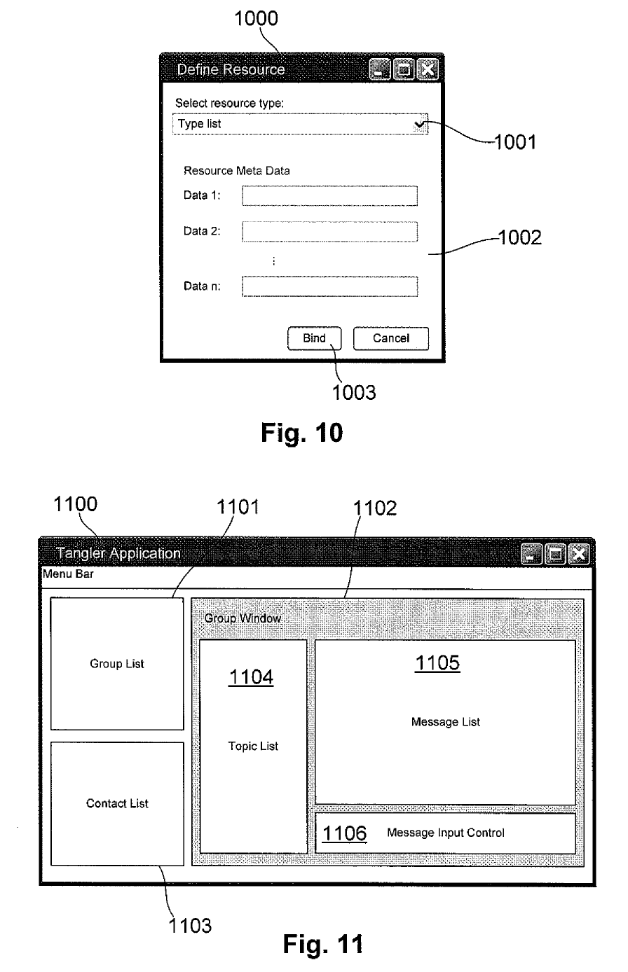

In one example, at step 620 the software application determines if the user is currently viewing a topic. If so, then at step 625 the client software application displays a resource dialog box to allow resource attributes to be selected or defined by the user at step 630. An example of this is shown in FIG. 10.

In this example, the dialog box 1000 includes a drop down list 1001 of compatible resource types, allowing the user to select a suitable resource type. The GUI also includes a number of fields 1002 that allow the user to enter resource attributes, such as metadata, or other information, regarding the resource. This may include information such as the resource location, which may be a URL (Universal Resource Locater), or the like, as well as other information, such as a song title, artist or the like in the case of music files.

This information can be determined by a combination of automated and manual processes, so that for example, if the user is currently listening to an MP3 music file, the client software application can import metadata associated with the file, with this being displayed in the fields 1002. This allows the user to review the attributes and modify or add to these if required.

It will be appreciated that creating the association using attributes rather than the resource itself can be more useful, as the resource attributes are typically more generic than the resource itself. Thus, for example, if a user is listening to a song, it is unlikely that an association between the actual MP3 file and a discussion topic would be of much interest to other users. However, by selecting attributes of the MP3 file, such as the artist, song title, album title, genre of music, or the like, and associating these with a discussion topic, this means other users will be able to locate the discussion topic using this information. In other words, other users can use any one or more of the resource attributes to locate the relevant discussion topic, and do not need to be listening to the same MP3 file.

However, the resource attribute can be the resource itself, which may be more relevant in other situations. Thus, for example, if the system is used in a company's Intranet environment, then an association with a resource, such as a Word document, may be more useful. It will be noted that in this example, the base station 101 may form part of the companies internal Intranet, and is not therefore accessible to user's outside the company.

As an alternative to the use of a dialogue box, any suitable input mechanism may be used, such as the use of an appropriate web-page hosted by the base station 101, or by dragging and dropping of resource attributes, such as a URL (Universal Resource Locator) into a suitable window or web-page.

In any event, the above processes allow the user to select the resource attributes, or create new resource attributes at step 630 with the client software application using these to generate an association request at step 635. In this instance, details of the discussion topic with which the resource attributes are to be associated can be determined automatically by the client software, and is not therefore described in further detail, but it will be appreciated that a dialog box, or other input means, may be used to allow this information to be defined manually. This may be achieved using a GUI similar to that shown in FIGS. 9A and 9B, which will be described in more detail below.

In the event that a resource is displayed, then it is necessary for a user to select a topic for creating an association. Accordingly, at step 640 the client software application can display a topic dialog box, an example of which is shown in FIGS. 9A and 9B.

In each of these examples, the dialog box 900 includes a field 901 for providing resource attributes, together with fields 902 which allow topics to be displayed and selected.

As shown in this example two different interfaces 900A, 900B are available. The interface 900A includes a bind option 903, which is used to bind a resource to a topic whereas the interface 900B includes a discuss option 904, which operates to bind the resource to the selected topics, as well as to allow a discussion to commence immediately. Thus, the binding will merely create the association, whilst the discuss option will not only create an association, but also cause the topic to be opened to allow discussion to commence immediately.

However, any suitable input technique, such as use of a web-page and/or dragging and dropping of a discussion topic page URL into a suitable location, may be used.

In any event, at step 645 the user selects a topic from the list or creates topics before selecting resource attributes at step 650. The resource attributes are attributes of the currently displayed resource, and in a manner similar to that described above with respect to step 625, may be determined automatically and/or manually. Thus, for example, the client software can use metadata associated with the currently displayed resource to populate the field 901. The user can then remove attributes not of interest, or additionally or alternatively, manually input the attributes as required.

As an alternative to performing steps 620 to 650, software application may display a generic browser page allowing resource and topic information to be entered by the user manually. As described above, other suitable means may also be used.

Once the topics and resource attributes are defined the software application generates the association request at step 635. This typically includes details of the resource attributes and topics that are to be associated, as well as any other information required to create the association.

In one example the association request is in the form of a custom message transferred from the end station 103 to the base station 101. However, additionally or alternatively, the association request may be formed from specific communications such as browser messages, or the like, particular when details of the resource attributes and/or discussion topics are submitted via a web-page, or the like.

At step 655 the association request is transferred to the base station 101, which uses this to create and store association data at step 660. The association data will indicate for each resource attribute, each associated topic and vice versa. In other words the association data provides a mapping between resource attributes and discussion groups or topics. It will be appreciated that in the above described process, the user may select several resource attributes or topics, and accordingly, the mappings between resource attributes and topics may define one-to-many, many-to-one and many-to-many, as well as one-to-one relationships.

The association data is typically stored in the database 111, allowing it to be subsequently retrieved. Additionally and/or alternatively, an indication can be provided to and/or stored at a host of either of the resource and/or the discussion forum.

As part of this process, an indication of the association may be provided to relevant parties, thereby allowing the parties to identify the association. This can be used in a number of ways, such as by allowing a host of a web-page to include a link to discussions that have been bound to the web-page using the above described process. In one example, some details regarding the discussion, such as a topic name or type, and/or parts of the discussion itself, may also be provided. This information can be used in a number of ways.

For example, a blogger may wish to present fragments of a discussion as part of their blog. Alternatively, a content provider may wish to assess use of copyright material, if links are provided thereto. It will also be appreciated that details of associated resources may be provided to discussion hosts, for inclusion in the relevant discussion group or topic.

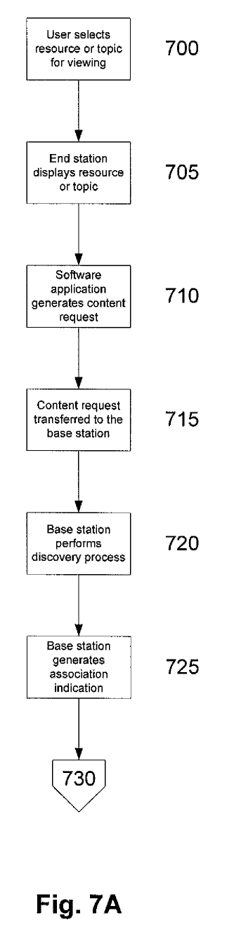

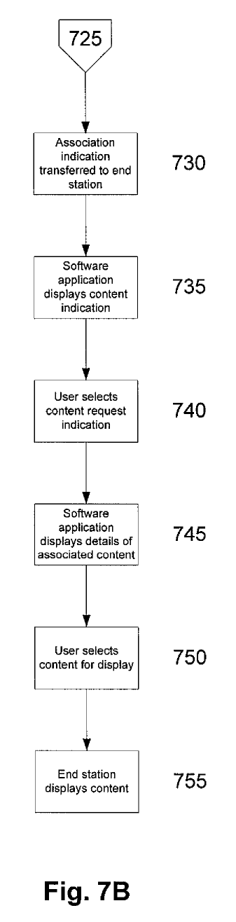

As a result of the creation of the association data, given any resource attribute or topic, it is possible for the processing system 110 to locate any associated topics or resource attributes (and hence resources in some cases). An example of the manner in which this is achieved will now be described with reference to FIGS. 7A and 7B.

In this example, at step 700 the user selects a resource or topic for viewing which again may be performed using a software application such as a client or a third party application. The resource or topic is displayed at step 705, with the software application generating a corresponding content request, at step 710, which is transferred to the base station 101 at step 715.

The content request will include attributes of the currently displayed resource or details of the displayed topic to thereby allow associated content to be located.

Thus, for example, if the user is viewing a web-page using a browser application this could be achieved using suitable browser messages transferred to the base station 101. Alternatively a client software application, operating as a toolbar, software plug-in, or the like, can detect the URL of the web-page and transfer at least this to base station 101. Optionally, the software may determine other resource attributes, such as metadata extracted from the web-page, or the like. Similarly, if the resource is an MP3 file, the client software application will typically determine attributes such as the song title, artist, album title, genre or the like.

The resource attributes and topic details may also include information regarding the viewing process such as the date and location of when the user is viewing the resource, or discussion topic.

In this example, the client software application generates the content request automatically as the resource or topic is displayed, in which case the resource attributes or topic details are selected automatically. This is not however essential and alternatively an icon can be displayed allowing the user to selectively request details of associated content. In this case, the resource attributes or topic details may be selected or modified manually, for example through the presentation of a suitable dialog box, web-page or the like.

At step 720 the base station 101 performs a discovery process to locate associated content. The discovery process will typically involve having the base station 101 at least search the association data generated using the above described process, allowing any associated topics and/or resource attributes (and hence resources) to be located.

However, in addition to this, the base station 101 may perform additional searching of other resources and topics, for which no association exists, as well as searching other types of content. This can be performed, for example, on the basis of the resource attributes, such as metadata or other information associated with the resource, or on the basis of information defining the discussion topic for discussion topics or the like.

It will be appreciated from this that the base station 101 may utilize existing searching techniques as part of this process.

A further point with this form of operation is that it allows multiple search criteria to be defined, so that if the content request includes details of several different resource attributes, these can be combined together to perform boolean searching or the like.

Thus, for example, if the resource attributes relate to a song, and include an artist, album name, song title and music genre, the discovery process could look for content, such as discussion topics, related to the artist, or song or album, or other content related to the same music genre. This effectively allows multiple searches to be performed simultaneously.

As mentioned above, the date and location of the user may also be provided, which can again be used in refining the discovery process. Thus, for example, users will be presented with content relevant to their current time and location, so that when viewing content associated with a music artist, this can allow the details of forthcoming concerts in the user's area to be identified.

A further feature of the discovery process is that the base station 101 can use the associations to further enhance any performed searching. Thus, for example, if the user is viewing a discussion topic, the base station 101 can determine any resource attributes associated with the discussion topic, using the association data. These resource attributes can then be used in a search process to locate associated content, including resources or discussion groups or topics.

Additionally, the use of associations allows multiple associations to be searched to determine content of greater relevance. For example, if the base station 101 receives a number of different resource attributes, the base station 101 can search all of the associations with these attributes. In the event that this results in a large amount of discussion topics, the base station 101 can review these and see if any discussion topics are identified by multiple ones of the resource attributes, indicating are likely to be of more relevance.

It will be appreciated that this therefore provides an extremely flexible search process for locating relevant content.

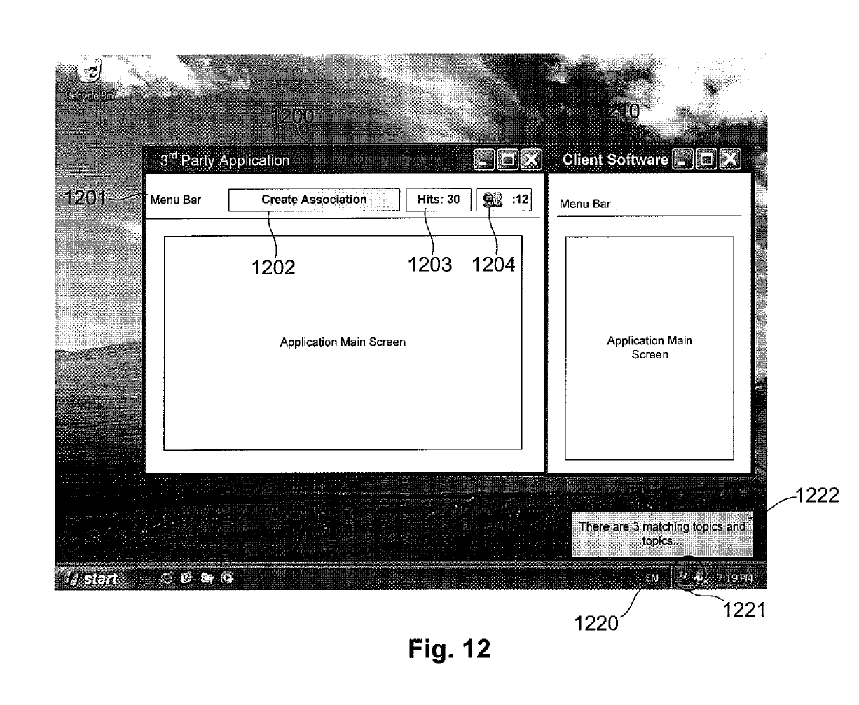

At step 725, the base station 101 generates an association indication which is transferred to the end station 103. The association indication includes details of associated content and this is used by the end station 103, at step 735, to allow the software application to display a content indication. The content indication will be in any one of a number of forms, such as a web-page, an icon or menu option, showing details of the available content. An example of this is shown in FIG. 12.

In this example, a GUI is presented to the user on the end station 103, including a third party application window 1200, a client software application window 1210 and a system tray 1220. The third party application window 1200 includes a menu bar 1201 having a create association indication 1202, a content indication 1203 and a use indication 1204. The system tray 1220 includes a notification tray icon 1221 and a notification pop-up 1222.

The content indication typically includes details, such as the number of content instances located, whilst the use icon indicates how many of the topics currently have users participating in the discussion.

The software application causes the content indication 1204 to be displayed together with the alternative representations 1221, 1222 and the use indication 1205. However, additionally information may be displayed in the client software application window 1210. It will be appreciated that any one or more of these may be displayed dependent on user configured preferences.

As an alternative however, search results may be displayed as a web-page. At step 740, the user can select the content request indication using a user input device such as a mouse, and this causes the client software application to display additional details of the associated content at step 745. Thus, for example, if the user selects the content indication 1204 this can cause a drop-down list to be displayed showing each of the available resources or resource attributes and/or topics.

This allows the user to select content for display at step 750 with this being displayed by the end stations 755.

Accordingly, the above described process provides a mechanism by which users can automatically be presented with context relevant content, including links to relevant resources, discussion topics or threads, or the like. In addition to this, the process can be used to create associations or bindings between specific resources and discussion topics, so that these may be more accurately and easily located subsequently.

The above described example has focused on the use of client software provided on the user's end station 103, to allow the binding and discovery processes to be performed. However, this is not essential.

For example, the functionality described above can be wholly implemented within third party applications, without requiring the use of a plug-in, or the like. Additionally, or alternatively, the process can be implemented on remote processing systems, such as network servers in a network environment.

Thus, for example, a web-page hosted by one of the end stations 105 could include a specific create association indication in the form of a hyperlink. In this instance, when the user is viewing the web-page, selecting the create association hyperlink will direct the user to a web-page that allows the user to enter details to be used in the creation of an association. Thus, for example, the user can be directed to a web-page that allows the user to select discussion topics, and/or define resource attributes, with these being provided to the base station 101 to allow the association to be created.

This operation could be achieved in a number of different ways, depending on the preferred implementation. Thus, for example, if the user is viewing a resource or discussion group or topic hosted by the end station 105, the end station 105 could effectively implement a software application similar to the client application described above. In this instance, the end station 105 effectively performs the method outlined above, with the user's end station 103 merely operating as an input device and display. Alternatively, any necessary links or the like could be encoded within the respective web-page, with the user's end station 103 communicating with the base station 101 as required.

Furthermore, when the user selects a “create association” link, the user can be presented with a web-page hosted by either the base station 101 or the end station 105, to allow details used in creating the association to be provided. Thus, for example, the create association link could be a link that redirects the web browser on the user's end station 103 to a web-page presented by the base station 101, which allows the user to define the association.

Similarly, when viewing a resource in the form of a web-page, the web-page may include an indication of any associated content determined through a discovery process. Again the discovery process can be initiated by having the end station 105, forward resource attributes to the base station 101, thereby allowing associated content to be discovered. Once this is completed, the relevant content indication can be provided by the end station 105 as part of the web-page displayed to the user.

It will also be appreciated that in a further variation the base station 101 may host content itself, and therefore act as a web server.

The term processing system is intended to cover any computer system or other form of processing device including, but not limited to, the end stations 103, 105 and/or the base station 101.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of associating a resource attribute and a discussion topic, wherein the method comprises, in an end station:
a) in response to display of at least one of a resource and a topic, and following user input indicative of a create association request, generating an association request indicative of:
i) a topic; and
ii) at least one resource attribute; and
b) transferring the association request to a base station, the base station being responsive to the association request to generate association data indicative of the association between the resource attribute and the topic.

2. A method according to claim 1, wherein the method further comprises, in the end station:
a) causing a create association indication to be displayed together with the displayed at least one of the resource and the topic; and
b) generating the association request in response to user selection of the create association indication.

3. A method according to claim 1, wherein the method further comprises, in the end station, in response to the display of a resource:
a) causing a list of available topics to be displayed; and
b) in response to user input, determining a topic by at least one of:
i) selecting one of the list of available topics; and
ii) creating a new topic.

4. A method according to claim 1, wherein the method further comprises, in the end station:
a) causing a list of resources attributes to be displayed; and
b) in response to user input, determining the at least one resource attribute by at least one of:
i) selecting one of the list of resources attributes; and
ii) creating a new resource attribute.

5. A method according to claim 1, wherein the resource attribute comprises at least one of the following:
a) partially based on resource metadata;
b) a uniform resource locator (URL);
c) a filename;
d) a resource author;
e) a resource title;
f) exchangeable image file (EXIF) information; and
g) a file property.

6. A method according to claim 1, wherein the topic comprises at least one of the following:
a) a discussion thread;
b) a discussion group; and
c) a chat room.

7. A method according to claim 1, wherein the resource comprises at least one of the following:
a) a web-page;
b) an rich site summary (RSS) feed;
c) a document;
d) a video sequence;
e) an image;
f) multimedia content; and
g) a data file.

8. A method according to claim 1, wherein the method further comprises, in an application executed by the end station:
a) determining the display of a resource by a second application executed by the end station;
b) causing a create association indication to be displayed;
c) determining user selection of the create association indication;
d) causing an interface to be displayed showing a list of available topics;
e) determining user selection of at least one of:
i) one of the list of available topics; and
ii) a new topic;
f) causing an interface to be displayed showing a list of resource attributes associated with the displayed resource;
g) determining user selection of at least one of:
i) one of the list of available resource attributes; and
ii) a new resource attribute;
h) generating the association request; and
i) transferring the association request to the base station.

9. A method according to claim 1, wherein the method further comprises, in an application executed by the end station:
a) determining the display of a topic by the application;
b) displaying a create association indication;
c) determining user selection of the create association indication;
d) displaying an interface showing a list of at least one of:
i) resource attributes; and
ii) resources;
e) determining user selection of at least one of at least one resource attribute using the interface;
f) generating the association request; and
g) transferring the association request to the base station.

10. A method according to claim 1, wherein the method further comprises, in the end station:
a) displaying a create association web-page hosted by a base station, the user being responsive to the create association web-page to provide details of at least one of the topic and the at least one resource attribute;
b) generating at least one browser message representing the association request; and
c) transferring the at least one browser message to the base station.

11. A method according to claim 10, wherein the method further comprises, in the end station:
a) displaying a first web-page hosted by a processing system, the first web-page including a create association indication;
b) determining user selection of the create association indication; and
c) transferring a browser message to the processing system, the processing system being responsive to the browser message to cause the create association web-page to be displayed by the end station.

12. A method according to claim 11, wherein the base station comprises the processing system.

13. A method of associating a resource and a discussion topic, wherein the method comprises, in a base station:
a) receiving, from an end station, an association request indicative of:
i) at least one topic; and
ii) at least one resource attribute; and
b) using the association request to generate association data indicative of an association between the resource attribute and the topic.

14. A method according to claim 13, wherein the method further comprises, in the base station:
a) causing the end station to display a create association web-page, the user being responsive to the create association web-page to provide details of at least one of the topic and the at least one resource attribute; and
b) receiving at least one browser message representing the association request.

15. A method according to claim 14, wherein the method further comprises, in the base station, hosting the create association web-page.

16. A method according to claim 15, wherein the method further comprises, in the base station:
a) causing the end station to display a first web-page, the first web-page including a create association indication, the end station being responsive to user selection of the create association indication to generate a browser message;
b) receiving the browser message; and
c) causing the create association web-page to be displayed by the end station.

17. A method of viewing content associated with at least one of a resource and a discussion topic, the method comprising, in an end station:
a) generating, in response to display of at least one of a resource and a topic, a content request;
b) transferring the content request to a base station, the base station being responsive to the content request to:
i) generate an association indication indicative any associated content; and
ii) transfer the association indication to the end station; and
c) using the association indication to display a content indication indicative of any content to the user.

18. A method according to claim 17, wherein the method further comprises, in the end station:
a) causing the content indication to be displayed together with the displayed at least one of the resource and the topic;
b) determining selection of the content indication in accordance with user input; and
c) causing the display of any associated content.

19. A method according to claim 17, wherein the content indication is indicative of a number of content items.

20. A method according to claim 17, wherein the method further comprises, in the end station:
a) determining at least one resource attribute associated with a displayed resource; and
b) generating the content request indication using the at least one resource attribute.

21. A method according to claim 17, wherein the method further comprises, in the end station:
a) determining at least one detail associated with a displayed topic; and
b) generating the content request indication using the at least one detail.

22. A method according to claim 17, wherein the content comprises at least one of a topic and a resource.

23. A method according to claim 17, wherein the topic comprises at least one of the following:
a) a discussion thread;
b) a discussion group; and
c) a chat room.

24. A method according to claim 17, wherein the resource comprises at least one of the following:
a) a web-page;
b) an rich site summary (RSS) feed;
c) a document;
d) a video sequence;
e) an image;
f) multimedia content; and
g) a data file.

25. A method according to claim 17, wherein the method further comprises, in an application executed by the end station:
a) determining the display of a resource by a second application executed by the end station;
b) determining at least one resource attribute associated with the resource;
c) generating the content request in accordance with the determined at least one resource attribute;
d) transferring the content request to the base station;
e) receiving the association indication from the base station; and
f) causing the content indication to be displayed.

26. A method according to claim 17, wherein the method further comprises, in an application executed by the end station:
a) determining the display of a topic;
b) generating the content request in accordance with the displayed topic;
c) transferring the content request to the base station;
d) receiving the association indication from the base station; and
e) causing the content indication to be displayed.

27. A method of viewing content associated with at least one of a resource and a discussion topic, the method comprising, in a base station:
a) receiving, from an end station, a content request indicative of at least one of a resource attribute and a topic;
b) using the content request to determine associated content;
c) generating an association indication indicative any associated content; and
d) transferring the association indication to the end station, the end station using the association indication to display a content indication indicative of any content to the user.

28. A method according to claim 27, wherein the method further comprises, in the base station, using at least one resource attribute to search content to thereby locate associated content.

29. A method according to claim 27, wherein the method further comprises, in the base station determining associated content using association data indicative of any associations between resource attributes and topics.

30. A method according to claim 27, wherein the content comprises at least one of a topic and a resource.

31. An apparatus for associating a resource attribute and a discussion topic, wherein the apparatus comprises an end station configured to:
a) in response to display of at least one of a resource and a topic, and following user input indicative of a create association request, generate an association request indicative of:
i) a topic; and
ii) at least one resource attribute; and
b) transfer the association request to a base station, the base station being responsive to the association request to generate association data indicative of the association between the resource attribute and the topic.

32. An apparatus for associating a resource and a discussion topic, wherein the apparatus comprises a base station configured to:
a) receive, from an end station, an association request indicative of:
i) at least one topic; and
ii) at least one resource attribute; and
b) use the association request to generate association data indicative of an association between the resource attribute and the topic.

33. An apparatus for viewing content associated with at least one of a resource and a discussion topic, the apparatus comprising an end station configured to:
a) generate, in response to display of at least one of a resource and a topic, a content request;
b) transfer the content request to a base station, the base station being responsive to the content request to:
i) generate an association indication indicative any associated content; and
ii) transfer the association indication to the end station; and
c) use the association indication to display a content indication indicative of any content to the user.

34. An apparatus for viewing content associated with at least one of a resource and a discussion topic, the apparatus comprising a base station configured to:
a) receive, from an end station, a content request indicative of at least one of a resource attribute and a topic;
b) use the content request to determine associated content;
c) generate an association indication indicative any associated content; and
d) transfer the association indication to the end station, the end station using the association indication to display a content indication indicative of any content to the user.

35. An apparatus for associating a resource and a discussion topic, comprising:
in response to display of at least one of a resource and a topic, and following user input indicative of a create association request, means for generating an association request indicative of: i) a topic and ii) at least one resource attribute; and
means for transferring the association request to a base station, the base station being responsive to the association request to generate association data indicative of the association between the resource attribute and the topic.
